(19) United States
(12) Patent Application Publication
(10) Pub. No.: US 2018/0142749 A1
(43) Pub. Date: May 24, 2018

(54) SPIRAL SPRING AND METHOD FOR ITS MANUFACTURING

(71) Applicant: Damasko Uhrenmanufaktur KG, Barbing (DE)

(72) Inventor: Stefan Maennicke, Wenzenbach (DE)

(21) Appl. No.: 15/860,824

(22) Filed: Jan. 3, 2018

Related U.S. Application Data
(63) Continuation of application No. PCT/IB2016/053970, filed on Jul. 1, 2016.

(30) Foreign Application Priority Data
Jul. 3, 2015 (DE) 102015110796.1
Jul. 14, 2015 (DE) 102015111359.7
Jul. 17, 2015 (DE) 102015111605.7
Aug. 5, 2015 (DE) 102015112897.7

(51) Int. Cl. F16F 1/02; F16F 1/10; C03C 15/00; G04B 17/06

(52) U.S. Cl. CPC F16F 1/024; F16F 1/10; F16F 1/021; C03C 15/00; F16F 2222/02; F16F 2224/02; F16F 2226/02; F16F 2226/04; G04B 17/066

(57) ABSTRACT

A spiral spring and a method of manufacturing the spiral spring are disclosed. The spiral spring includes at least one winding, which includes a core made of a silicon material. The core comprises two long, parallel, straight sides, and two short, parallel, straight sides. At least the opposite long sides of the core are covered by a SiO₂ layer. In the method, the at least one winding is etched out of the silicon material such that the core of the at least one winding of the spiral spring is formed and includes two long, parallel, straight sides and two short, parallel, straight sides.

### CROSS-REFERENCE TO RELATED APPLICATIONS

The present application is filed under 35 U.S.C. §§ 111(a) and 365(c) as a continuation of International Patent Application No. PCT/IB2016/053970, filed on Jul. 1, 2016, which application claims priority from German Patent Application No. DE 10 2015 110 796.1, filed on Jul. 3, 2015, German Patent Application No. DE 10 2015 111 359.7, filed on Jul. 14, 2015, German Patent Application No. DE 10 2015 111 605.7, filed on Jul. 17, 2015, and German Patent Application No. DE 10 2015 112 897.7, filed Aug. 5, 2015, which applications are incorporated herein by reference in their entirety.

### FIELD

The present invention relates to a spiral spring with at least one winding. The spiral spring consists of one solid core of a silicon material. The core comprises two long, parallel, and straight sides, and two short, parallel, and straight sides. The invention further relates to a method for the manufacturing of a spiral spring for mechanical clockworks. The invention similarly relates to a mechanical clockwork which has the inventive spiral spring installed.

### BACKGROUND

Oscillation systems for mechanical clockworks, in particular for wrist watches, are referred to by experts as balance wheels. The balance wheel comprises an oscillation body, which can be rotated around an axis of rotation using a balance shaft. A spiral spring and balance spring are further provided, which, together with the mass of the oscillation body, form the rotatable and ticking system.

For the manufacturing of the spiral springs, tolerances cannot be ruled out. This is even more so the case for spiral springs made of silicon, which have a uniform coating of silicon oxide on their surfaces and exterior surfaces, in order to attain the necessary rigidity and/or temperature independence. As a rule, this coating is performed through thermal oxidation.

EP 1 422 436 A1 discloses a method for the manufacturing of spiral springs for the oscillation system of mechanical watches made of monocrystalline silicon. Here, the silicon core of the spiral spring is completely encased in silicon oxide.

The European patent application EP 2 284 628 A2 discloses a resonator (spiral spring), which is thermally compensated and possesses a core of monocrystalline silicon. In accordance with one embodiment, the thermal oxidation of the spiral springs is formed such that at least one exterior surface of the oscillation region of the core has a coating, and at least one other surface has no coating. In accordance with another embodiment, the oscillation region of the core has a coating on at least two adjacent exterior surfaces, where these coatings differ in their respective thickness.

The European patent application EP 2 589 568 A1 discloses a micro-mechanical part, which comprises a core of a semiconductor material and a coating of an electrically insulating material, such as diamond or silicon dioxide. The coating is formed on a surface of the core. The core features an inner layer and an outer layer, where the electrical conductivity of the outer layer is greater than that of the inner layer.

The Swiss patent application CH 699 780 A2 discloses a spring which consists of a silicon rod with an exterior surface. The silicon rod has a modulus of elasticity, and a thermal expansion coefficient. A material is provided, which partially compensates the thermal coefficient, where the material is Invar, Elinvar, Kovar, or silicon dioxide. The material is applied to the silicon rod in the form of a covering.

The international patent application WO 2011/7072960 A1 discloses a thermally compensated resonator. The body of the resonator has a core made of silicon material. The body of the core has at least a first and a second coating, which are selected such that the thermal expansion is essentially zero.

The U.S. Pat. No. 8,562,206 discloses a spiral spring. Each winding of the spiral spring has multiple openings that extend through the spirals of the spring.

The international patent application PCT/IB2015/054783 relates to a spiral spring and method for the manufacturing of a spiral spring. The spiral spring has a spiral spring mounting section, and a subsequent oscillation region, which possesses at least one winding. The core of the spiral spring is made of silicon. At least two long lateral surfaces of the core join at least two short lateral surfaces to one another. In at least one upper lateral surface, and along a winding of the oscillation region, at least one depression is formed in a second partial region in the SiO₂ layer, whose depth extends at least to the core of the silicon.

The international patent application WO 2014/203086 A1 discloses an oscillation system for mechanical clockworks, a spiral spring, and a method for the manufacturing of a spiral spring. The spiral spring has a spiral spring mounting section, a subsequent oscillation region with at least one winding, and a stabilization region following the oscillation region. Before the thermal oxidation, a core of silicon possesses an essentially constant cross-section over the length of the oscillation region. After the thermal oxidation, the spiral spring features at least one first partial region with a first height, and at least one second partial region with a second height in the oscillation region. Here, the first height is greater than the second height.

### SUMMARY

The object of the invention is to provide a spiral spring that demonstrates a long-term excellent oscillation behavior, is free of warping in the plane of the spiral spring, and possesses stability against spring fractures. The spiral spring should also be reproducible in terms of its oscillation behavior, without neglecting the necessary temperature compensation.

A further object of the invention is to provide a method for the manufacturing of a spiral spring for mechanical clockworks, which can be performed simply and reliability, and results in a spiral spring with a long-term, excellent oscillation behavior, which also demonstrates the necessary temperature compensation, is free of warping in the plane of the spiral spring, and possesses stability against spring fractures.

A possible embodiment of the spiral spring is that at least one winding of the spiral spring comprises at least one winding, which consists of a solid core of a silicon material. The core has two long, parallel, straight sides, and two short, parallel, straight sides. In order to compensate the thermal expansion coefficient, at least the straight, long sides of the core that are opposite to one another are covered by a layer for the compensation of the thermal expansion coefficient. The layer is preferably a SiO₂ layer.

A further embodiment for the spiral spring is that the upper short, straight sides, and the two opposing long sides are enclosed in a layer, preferably a SiO₂ layer.

A further embodiment of the spiral spring is that it comprises at least one winding that consists of a solid core made of a silicon material. The core itself essentially comprises two long, parallel, straight sides, and two short, parallel, straight sides, among other things. The upper short, straight side is joined to the opposing long sides on both sides by an continuously differentiable upper section, respectively. The opposing long and straight sides, the continuously differentiable respective upper sections which join the upper short and straight sides to the opposing long and straight sides on both sides, and the upper short and straight sides are covered by a SiO₂ layer.

The lower short, straight side is also joined to the opposing long, straight side on both sides by a continuously differentiable upper section, respectively. The core is covered by a SiO₂ layer at least at the opposing long, straight sides, and at least partially at the respective, continuously differentiable upper section, and the respective, continuously differentiable lower section.

The spiral spring could be designed such that the two continuously differentiable upper sections differ from the continuously differentiable lower sections.

In accordance with a possible embodiment of the spiral spring, the short lower side and the short upper side have a SiO₂ layer, such that the core is surrounded by a SiO₂ layer. The thickness and/or form of the SiO₂ layer differ at the lower short side and the upper short side. The thickness of the SiO₂ layer can be between 2 μm and 5 μm.

The spiral spring itself comprises a spiral spring mounting section, a spiral spring end section, and at least one spiral spring ring section lying between them, which comprises the multiple windings of the spiral spring. The spiral spring can be installed in a mechanical watch.

The core of the spiral spring can consist of amorphous silicon, partially amorphous silicon, polysilicon, a monocrystalline silicon structure, or a silicon sintering material. The spiral spring preferably consists of a polycrystalline silicon material. The polycrystalline silicon material can be produced in various ways. A chemical vapor deposition (CVD) or an epitaxy deposition of the polycrystalline silicon may occur, for example, in that the resulting starting material forms a thin layer or a wafer, whose thickness is equal or essentially equal to the thickness corresponding to the height of the spiral springs to be manufactured. A CVD is also conceivable for the production of polycristalline silicon. In doing so, initial wafers or thin layers are obtained, from which the spiral springs can be manufactured. Similarly, polycristalline silicon can be obtained through sublimation with the Physical Vapor Transport (PVT) method. The polycristalline silicon is formed through sublimation of silicon, or silicon carbide on the barrier layer, with the thickness that is equal, or essentially equal to the thickness that the spiral spring to be manufactured should have. A casting of polycrystalline silicon is also possible. A further possibility for the production of polycrystalline silicon is the Siemens process. Wafers are cut and, if needed, the required thickness is lapped from the silicon hereby produced, the thickness being essentially equal in height to the spiral springs to be manufactured.

The inventive method for the manufacturing of a spiral spring from a silicon material is designed through the following steps, in accordance with a possible embodiment: provision of a support, where the support can have the form of a wafer; application of a silicon material to the support, where the silicon material forms a core of at least one winding of the spiral spring; etching of the at least one winding of the spiral spring, such that the core of the at least one winding of the spiral spring is formed, comprising two long, parallel, straight sides and two short, parallel, straight sides; performance of a thermal oxidation, where a layer of an oxide grows at least on the lateral surfaces of the spiral spring defined, and exposed by the long sides; and removal of the support from the silicon material.

In accordance with a possible embodiment of the method, during the performance of the thermal oxidation, the layer of the oxide grows on the lateral surfaces, defined and exposed by the long sides, and on the lateral surfaces of the spiral spring, defined and exposed by the upper, short, straight sides.

In a possible embodiment of the etching process of the at least one winding of the spiral spring, the core of the at least one winding of the spiral spring is formed. Two long, parallel, straight sides, and two short, parallel, straight sides are hereby created. The upper short, straight side is joined to the opposing long sides on both sides by a continuously differentiable upper section, respectively.

In a further embodiment of the etching process of the at least one winding of the spiral spring, the core of the at least one winding of the spiral spring is formed. Two long, parallel, straight sides, and two short, parallel, straight sides are hereby created. The upper short, straight side is joined to the opposing long sides on both sides by a continuously differentiable upper section, respectively. Similarly, a lower short, straight side is joined to the opposing long sides on both sides by a continuously differentiable lower section, respectively.

In order to form the continuously differentiable lower section, the etching of the at least one winding of the spiral spring is performed, such that a rear etching is formed in the region of the lower side of the core. The rear etching is formed such that at least the continuously differentiable lower section which joins the opposing long sides with the lower short and straight sides on both sides, respectively, is spaced apart from the support.

A further embodiment of the etching process is that a separating layer is provided between the support and the silicon material for the core of the at least one winding of the spiral spring. The etching of the at least one winding of the spiral spring is performed such that in the region of the lower, short, straight side of the core, a rear etching is formed at least in the separating layer. Through the rear etching, at least the continuously differentiable lower section which joins the opposing long sides with the lower short and straight sides on both sides, respectively, is spaced apart from the support. Further, the parameters of the etching process can be adjusted such that etching is performed below an original level of the support. This means that material of the support is eroded in certain regions.

Subsequent to the etching process, a layer of a material for the compensation of the thermal expansion coefficient of the silicon material of the core of the windings is applied to the boundary surfaces—exposed by the etching process—of the at least one winding. The material for the compensation of the thermal expansion coefficient is preferably the same material as that of the separating layer. In accordance with an especially preferred embodiment, the material of the layer for the compensation of the thermal expansion coefficient of the silicon material is a SiO₂ layer. The SiO₂ layer is formed by way of thermal oxidation of the silicon material of the core. Finally, the removal of the support takes place, which can be performed mechanically and/or chemically.

The “active oscillation region” of the spiral spring extends from the inner end of the active oscillation region, which adjoins to the spiral spring mounting section of the spiral spring, to the outer spring holding point and spiral spring end section.

A further embodiment of the invention relates to a spiral spring with a spiral spring mounting section, a spiral spring end section, and at least one spiral spring ring section lying between them, which possesses at least one winding. As a rule, the spiral spring ring section has multiple windings. The spiral spring has a solid and polygonal core, made of silicon material with at least two long sides, and at least two short sides. Two opposing long sides, together with an upper short side, are coated in a SiO₂ layer. At the respective transition points from the upper, short side to the long sides, the core has an upper round, and a continuously differentiable upper section. Further, at the respective transition points from the lower, short side to the long sides, the core has a lower round, and a continuously differentiable lower section. The upper round and lower round are similarly coated with the SiO₂ layer.

The inventive spiral spring has the advantage that it possesses the mechanical stability required for a smooth oscillation behavior, the necessary temperature compensation, and absence of warping. Additionally, the inventive spiral spring, which has a reduced weight, also protects the bearings of the spiral spring, which has a positive effect on the accuracy of the watch, and an extension of the service intervals.

As a rule, the core of the spiral spring is rectangular, and thus possesses two long sides and two short sides, which at least form over the length of the oscillation region two long lateral surfaces through two long sides, and two short lateral surfaces through two short sides. The core thus has two opposing long lateral surfaces, and two opposing short lateral surfaces.

The rounds that are formed (continuously differentiable sections of the core) differ, for example, in the radii of the upper round and the radii of the lower round. It is the rounds on the corners of the core that prevent mechanical voltage peaks, which, in turn, reduces the risk of fracture of the spiral spring.

In accordance with a possible embodiment, the spiral spring can also have a SiO₂ layer on the lower short side. The SiO₂ layer on the lower side can have a lesser thickness than the SiO₂ layer on the upper short side, or on both long, parallel sides. In this embodiment, the SiO₂ layer is applied to the lower short side in a second step of thermal oxidation. The duration of the thermal oxidation of the lower short side is selected such that a SiO₂ layer grows with a lesser thickness than the thickness of the SiO₂ layer, on both lateral surfaces and the upper surfaces. The thickness of the SiO₂ layer on the lower lateral surface formed by the lower short side is less than 2,000 nm. The preferred thickness is in the range of 750 mn to 500 nm. The core of the spiral spring is preferably made of polysilicon.

During the thermal oxidation of the core, upper rounds form at the respective transition points from the upper short side to the long sides, and lower rounds form at the respective transition points from the lower short side to the long sides.

In accordance with an embodiment of the method, a separating layer may be applied to the support, before the application of the material forming the core of the spiral spring on the support. Similarly, the material for the core of the spiral spring may have a separating layer. The wafer with the material for the windings of the spiral spring, and the separating layer are, for example, bonded to the support.

The spiral springs produced and exposed during the etching process are still connected to the material layer. The material layer with the spiral springs can be at least partially removed from the support, or from the support with the separating layer, through mechanical and/or chemical methods. In accordance with a possible embodiment, the support, or the support and the separating layer, can be removed in a region that is smaller than the diameter of the support. This has the advantage that sufficient material for manipulation is still available on the margin for the manipulation.

It is also possible that before the at least partial removal of the support, the separating layer, which is preferably also a SiO₂ layer, is eroded in the free regions through an etching process. After the subsequent removal of the support, exposed cores of the spiral springs are obtained, which have the separating layer of SiO₂ on the lower side.

After the support, or the support and the separating layer, have been removed, the further thermal oxidation can performed at the upper short side, and the opposing lower short side, provided it has no coating. The duration of the thermal oxidation is measured such that the thickness of the oxide layer applied (approximately 2,000 nm) is smaller than the thickness of the oxide layer on the lateral surfaces and the upper lateral surfaces of the spiral spring. The duration of the thermal oxidation is preferably less than 1.5 hours, and the especially preferred duration of the thermal oxidation is less than 1 hour.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is an exemplary perspective view of an oscillation system for clockworks of mechanical watches, in accordance with the state of the art;

FIG. 2 is an exemplary section along a plane incorporating the axis of the balance shaft through the oscillation system of the clockwork, in accordance with FIG. 1;

FIG. 3 is an exemplary perspective lateral view of the exposed components of the oscillation system, in accordance with FIGS. 1 and 2 for a clockwork;

FIG. 4 is a perspective view of the spiral spring, in conjunction with the balance wheel of a clockwork;

FIG. 5 is a view of the cross-section through a winding of the spiral, which possesses a core made of silicon material;

FIGS. 6A-6D show a schematic representation of the sequence of a possible embodiment of the method for the manufacturing of a spiral spring;

FIGS. 7A-7D a schematic representation of a further embodiment of the sequence of the method for the manufacturing of a spiral spring;

FIGS. 8A-8C show a possible embodiment of the formation of the cross-section of the windings of a spiral spring;

FIG. 9 is a schematic representation of the partial cross-section of the spiral spring in the upper region of the spiral spring, after the thermal oxidation;

FIG. 10 is a schematically enlarged view of a cross-section, in which the individual windings of the spiral spring have been exposed through etching of the surrounding silicon material;

FIG. 11 is an enlarged view of a cross-section, in which the individual windings of the spiral spring which were treated with a thermal oxidation are still connected to the support;

FIG. 12 is a schematically enlarged view of a cross-section of the winding of the spiral spring, which has been surrounded by an oxide layer, due to the thermal oxidation, and has been removed from the support;

FIG. 13 is a schematically enlarged view of a cross-section of another embodiment, in which the individual windings of the spiral spring have been exposed through etching of the surrounding silicon material;

FIG. 14 is an enlarged view of a cross-section of the embodiment in FIG. 13, in which the individual exposed windings of the spiral spring, which were treated with a thermal oxidation, are still connected to the support;

FIG. 15 is a schematically enlarged view of a cross-section of the oxidized winding of the spiral spring in FIG. 14, in which the support is removed;

FIG. 16 is a schematically enlarged view of a support with a separating layer, upon which a layer of silicon material is present for the core of the windings of the spiral spring;

FIG. 17 is a schematically enlarged view of the layer of silicon material, from which the windings of the spiral spring are etched;

FIG. 18 is a schematic representation, in which the etched windings have a oxide layer due to thermal oxidation;

FIG. 19 is a schematic representation of the support with the windings, in which the oxide layer is completely removed, and the separating layer is at least partially removed; and,

FIG. 20 is a schematic representation of the windings, in which the exposed regions of the lateral surfaces have been subjected to an additional thermal oxidation.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

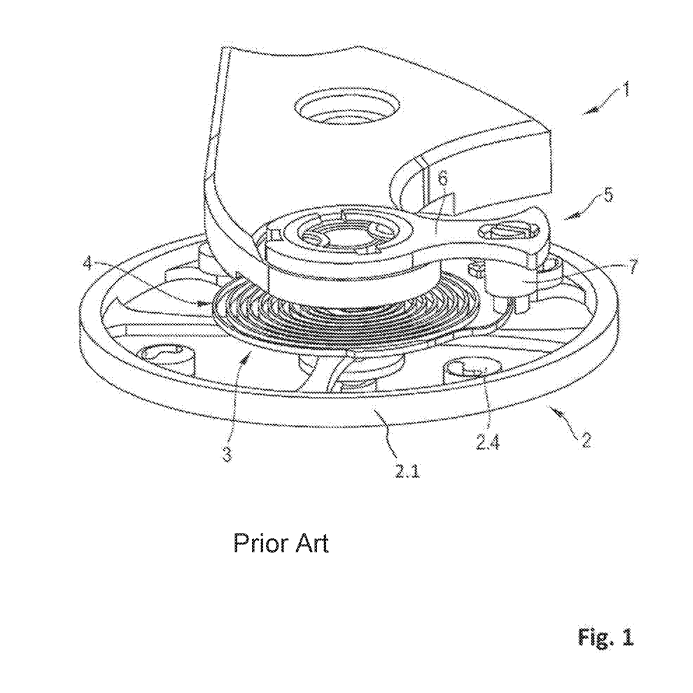

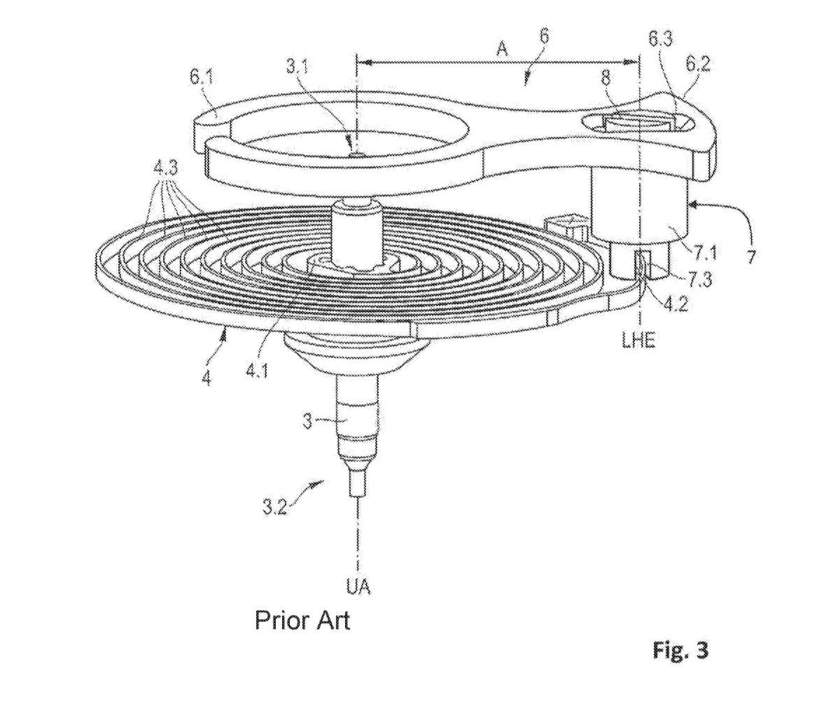

In order to better understand the present invention and the technical environment in which the invention is used, an oscillation system for mechanical clockworks, which is known from the state of the art will be described in conjunction with FIGS. 1 through 3.

Oscillation system 1 comprises an oscillation body in the form of fly wheel 2, balance shaft 3, and spiral spring 4. Fly wheel 2 consists of outer annular ring section 2.1, which is joined with nave section 2.3 through several spokes 2.2. Nave section 2.3 features a central through-hole deviating from the annular form, in which allocated shaft section 3′ of balance shaft 3 is received, whose concentric exterior creates a tight fit with nave section 2.3 of fly wheel 2. Fly wheel 2 is thus connected to balance shaft 3 in a torque-proof manner. Further, several fly wheel masses 2.4 are attached to the interior of outer annular ring section 2.1, the interior facing the center of rotation of fly wheel 2.

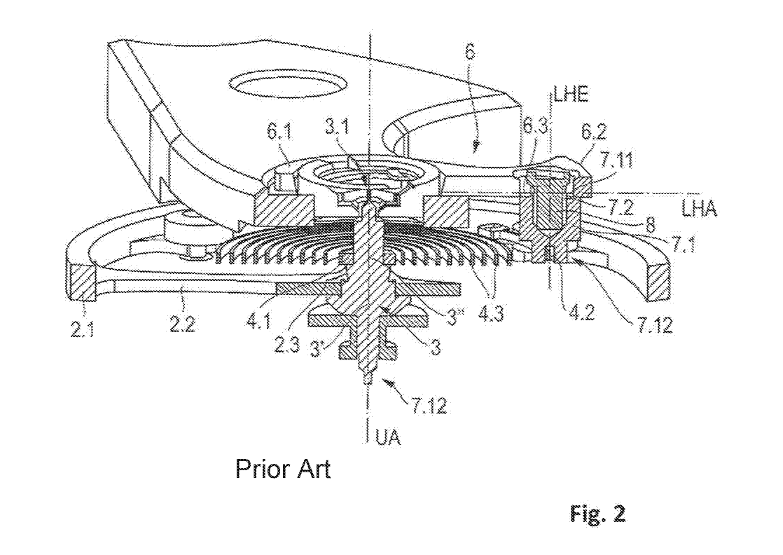

Balance shaft 3 further features upper and lower free end 3.1, 3.2 which taper off, and are received in the correspondingly formed upper and lower bearing units for rotatable bearing of balance shaft 3 by axis UA. FIGS. 1 and 2 show an exemplary upper bearing unit. Axis UA of balance shaft 3 is thus simultaneously the rotational axis of fly wheel 2 and the axis of spiral spring 4.

Spiral spring 4 consists of a preferably ring-shaped, inner spiral spring mounting section 4.1 and outer spiral spring end section 4.2. In between these, there are several spiral spring ring sections 4.3, which run in a plane that is vertical and preferably concentric to the axis of spiral spring 4, which corresponds with axis UA of balance shaft 3.

The preferably ring-shaped inner spiral spring mounting section 4.1 is connected to balance shaft 3 in a torque-proof manner, preferably with adhesive and/or using tight fit. For this purpose, balance shaft 3 features shaft section 3″ which is formed for the reception of inner spiral spring mounting section 4.1, which is arranged above shaft section 3′ which receives fly wheel 2.

In order to provide the mounting of outer spiral spring end section 4.2, which is torque-proof with respect to balance shaft 3, holding arrangement 5 is provided for adjusting the center of spiral spring 4. Holding arrangement 5 comprises at least holding arm 6, and holding element 7, which is attached in a slidable manner in the region of the outer free end of holding arm 6 along longitudinal axis LHA of holding arm 6.

Holding arm 6 features inner holding arm end 6.1, and outer holding arm end 6.2, where inner holding arm end 6.1 forms an open annular ring, and longitudinal guide groove 6.3 is provided in the region of outer holding arm end 6.2. Longitudinal guide groove 6.3 is provided for the variable mounting of holding element 7 on holding arm 6. Inner holding arm end 6.1 is attached in a torque-proof manner by way of a holding method, which will not be described in further detail, and which can also receive the upper and lower bearing units for the rotatable bearing of balance shaft 3, such that the open annular ring of inner holding arm 6.1 concentrically surrounds axis UA of balance shaft 3.

Holding element 7 features an essentially cylindrical, longitudinal base body 7.1, with upper and lower front face 7.11, 7.12, and longitudinal axis LHE, which features blind borehole 7.2 that is opened towards upper front face 7.11, and has an inner threading for receiving screw 8. Using screw 8, which is guided through longitudinal guide groove 6.3 of holding arm 6, holding element 7 can be screwed tight to holding arm 6, such that :longitudinal axis LHA of holding arm 6 and longitudinal axis LHE of holding element 7 run vertically to one another.

On opposing lower front face 7.12 of base body 7.1 of holding element 7, guide groove 7.3 extending vertically to longitudinal axis LHE of base body 7.1, and opening downwards, is provided, which is formed for the radially guiding reception of outer spiral spring end section 4.2. A plane receiving longitudinal axis LHE of base body 7.1 divides guide groove 7.3 into approximately two opposing, equal halves of the fork-like lower free end of holding element 7.

In the mounted state, by way of holding arrangement 5, radial distance A between axis UA of balance shaft 3, and longitudinal axis LHE of holding element 7, and thus outer spiral spring end section 4.2, are adjustable. Through a corresponding radial sliding of holding element 7, and thus of outer spiral spring end section 4.2, towards axis UA, the spiral spring center is adjustable, and preferably such that spiral spring ring sections 4.3 have the same distance from one another and run concentrically around axis UA.

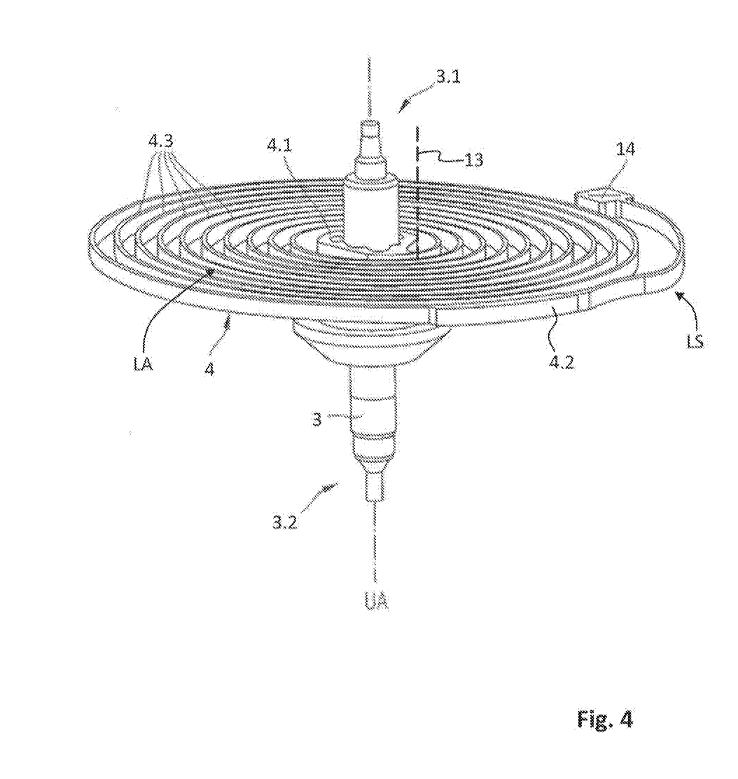

FIG. 4 shows a perspective view of a possible embodiment of spiral spring 4, which is connected by spiral spring mounting section 4.1 in a torque-proof manner to balance shaft 3. Oscillation region LA is formed by spiral spring ring sections 4.3 of spiral spring 4, which form the several windings of the spiral spring. Spiral spring ring sections 4.3 extend from inner end 13 of spiral spring mounting section 4.1 to stabilization region LS, and form oscillation region LA. The embodiment of the stabilization region shown here illustrates one of several possible embodiments, and should not be interpreted as a limitation of the invention.

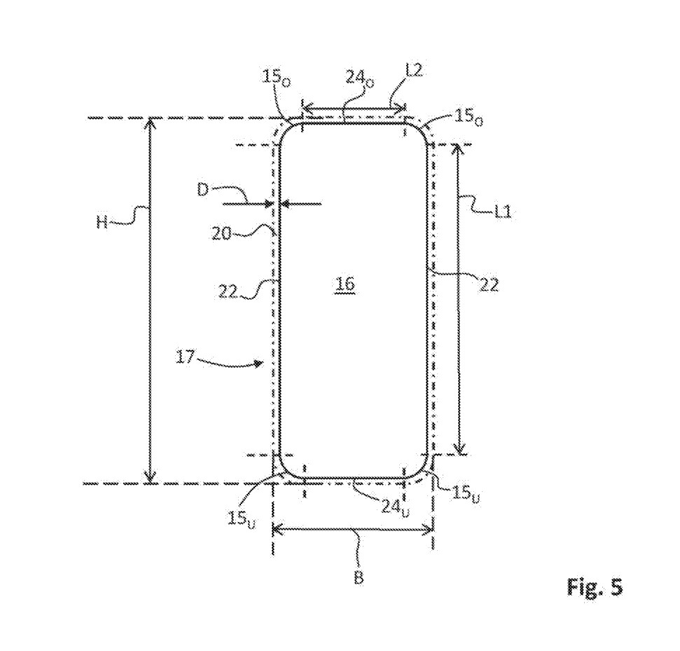

FIG. 5 shows cross-section 17 through winding 9 of spiral spring 4. Cross-section 17 is essentially constant over the entire length of windings 9 of oscillation region LA. Windings 9 of spiral spring 4, which is produced for installation in oscillation system 1 of a watch, consists of core 16 made of silicon material. The silicon material can consist of, for example, polycrystalline silicon, sintered silicon, or a monocrystalline silicon structure. For the compensation of the thermal expansion coefficient, core 16 is at least partially surrounded by a layer of a material. In the embodiment shown here, the layer of the material covers core 16 completely. Embodiments are also possible in which only lateral surfaces of windings 9 of the spring are coated with the material for temperature compensation. In accordance with a preferred embodiment, layer 20 is produced through thermal oxidation of core 16. Formed layer 20 is a SiO₂ coating with thickness D between 2 μm and 5 μm. Cross-section 17 possesses height H and width B. Cross-section 17 is formed such that opposing long and straight sides 22 possess length L1 that is smaller than height H. Lower, short, and straight side 24_{U} and upper, short, and straight side 24_{O} have length L2 that is smaller than the width of cross-section 17. Core 16 is further designed in cross-section 17 such that upper short, straight side 24_{O} is joined to opposing long sides 22 on both sides by continuously differentiable upper section 15_{O}, respectively. Similarly, lower short, straight side 24_{U} can be joined to opposing long and straight sides 22 of core 16 on both sides by continuously differentiable upper section 15_{U}, respectively.

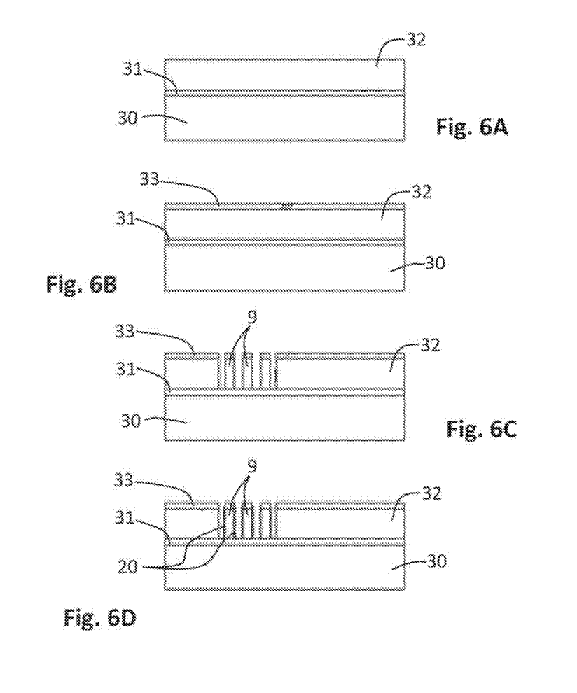

In FIGS. 6A through 6D a schematic representation is shown of the sequence of a method for the manufacturing of a micromechanical component, in particular spiral spring 4 with windings 9. Support 30 is provided, upon which silicon material 32 can be applied in a layer thickness that essentially corresponds to the height of core 16 of spiral spring 4. Separating layer 31 is provided between silicon material 32 and support 30 in this embodiment. Separating layer 31 can be applied to support 30. Subsequently, silicon material 32 is then applied to separating layer 31. A further possibility is for separating layer 31 to be applied to silicon material 32. A wafer made of silicon material 32 with separating layer 31 is, for example, bonded to support 30. The separating layer SiO₂ is preferred. The application and formation of silicon material 32 can be performed through a variety of methods according to the state of the art and known those having ordinary skill in the art. Finally, layer 33 is applied to the free surface of silicon material 32 for the micromechanical component and spiral spring 4, which prevents the growth of an oxide during the thermal oxidation. In the embodiment of the method described here, layer 33 is, for example, a silicon nitride layer. The component and windings 9 of spiral spring 4 are exposed by way of the etching. Subsequently, a thermal oxidation is performed, where SiO₂ layer 20 is formed on exposed surfaces of the component and windings 9 of spiral spring 4. Finally, there is the detachment or separation of the layer made of silicon material 32, which contains the micromechanical components and spiral springs 4, from support 30. The micromechanical components and spiral springs 4 are still connected to the layer made of silicon material 32 for the micromechanical component and spiral springs 4. The detachment or separation of the layer made of silicon material 32 from support 30 can occur by way of chemical, mechanical, or chemical-mechanical processes.

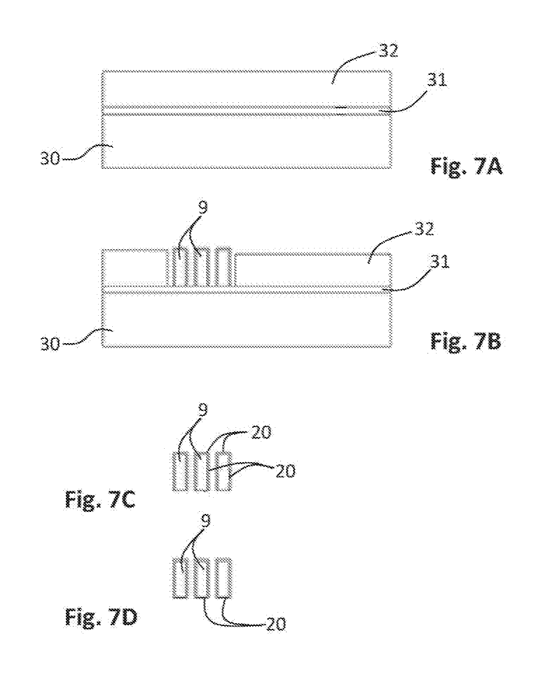

In FIGS. 7A through 7D, a schematic representation of a further embodiment of the sequence of the method for the manufacturing of windings 9 of spiral spring 4 is shown. Although the subsequent description refers to the manufacturing of spiral spring 4, this should not be interpreted as a limitation of the invention. Here, too, separating layer 31 is provided between support 30 and the layer made of silicon material 32. Separating layer 31 between support 30 and the layer made of silicon material 32 can be foregone. The layer made of silicon material 32 can thus be directly applied to support 30. In the case of separating layer 31, this is made of SiO₂.

Similarly, in this embodiment, no material preventing the thermal oxidation is applied to the layer made of silicon material 32 for the spiral spring. After the etching and exposure of windings 9 for spiral springs 4, there occurs a first step of the thermal oxidation. Here, the layer made of silicon material 32, which surrounds spiral springs 4, is still connected to support 30. In the first step of the thermal oxidation, SiO₂ layer 20 grows on the lateral surfaces defined by long and straight sides 22 (not shown here) and on the upper lateral surface of core 16 of the spiral spring defined by the upper, short, and straight side 24_{O}. After the first step of the thermal oxidation, support 30 and here, too, separating layer 31, are mechanically and/or chemically eroded. A mechanical erosion can occur, for example, through grinding.

After the removal of support 30 the lower lateral surface of core 16 of spiral spring 4 defined by the lower, short, and straight side 24_{U} is thus exposed. In a second step of the thermal oxidation, in one embodiment of the method, SiO₂ layer 20 can also be applied to the lower lateral surface of core 16 of spiral spring 4. It is possible that SiO₂ layer 20 on the lower lateral surface of core 16 possesses a lesser thickness than SiO₂ layer 20 on the remaining lateral surfaces of core 16 of windings 9 of spiral spring 4.

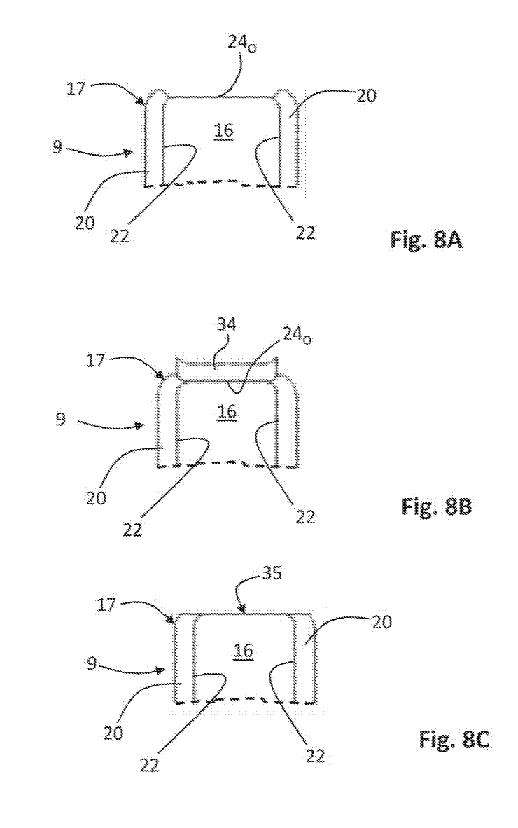

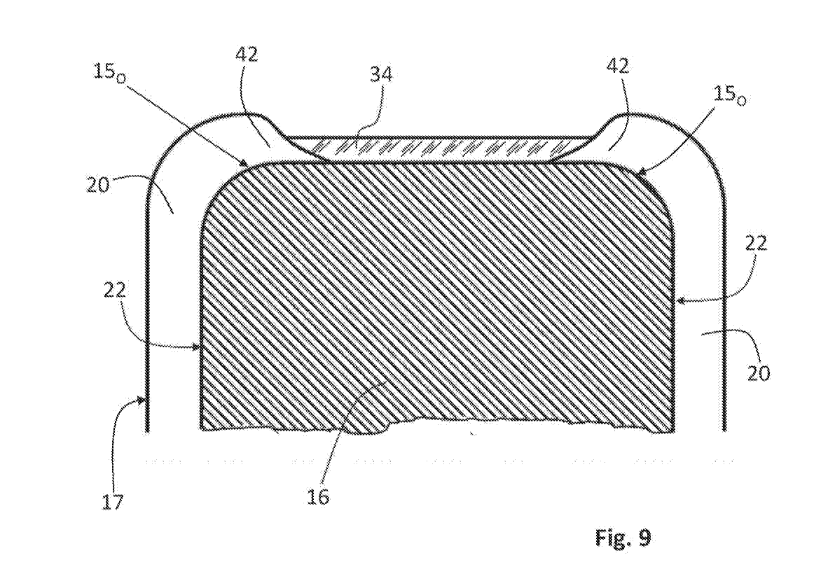

FIGS. 8A through 8C show embodiments of the formation of cross-section 17 of windings 9 of spiral spring 4. Two opposing sides 22 have SiO₂ layer 20 at least over the length of oscillation region LA. At least on upper short side 24_{O} at the respective transition points to long sides 22, core 16 has the continuously differentiable upper section 15_{O}, described in FIG. 5, which is also covered by SiO₂ layer 20. In the embodiment shown in FIG. 8A, SiO₂ layer 20 at upper short side 24_{O} is taller than the level of core 16. There is no oxide layer on the surface of windings 9, defined by upper short side 24_{O}, because this region of windings 9 was masked. This embodiment of the upper marginal regions of spiral spring 4 extends at least along the oscillation region of spiral spring 4.

FIG. 8B shows a further embodiment of the formation of cross-section 17 of windings 9 of spiral spring 4, where core 16 at upper short side 24_{O} has masking 34 (preferably silicon nitride). This embodiment of the upper marginal regions of spiral spring 4 extends at least along the oscillation region. During the thermal oxidation, an oxide in the form of a bird beak grows between masking 34 preventing the thermal oxidation and the material of core 16. This results in a bulge of masking 34. In accordance with a possible embodiment, the mask can be removed at least section-wise along the oscillation region in the design of the upper margin regions of spiral spring 4.

FIG. 8C shows yet another embodiment of the formation of cross-section 17 of windings 9 of the spiral spring. Here, SiO₂ layer 20 on upper short side 24_{O} has been removed down to core 16. Similarly, masking 34 described in FIG. 8B can be removed, such that core 16 is exposed. Through the mechanical grinding process, masking 34 and an upper part of SiO₂ layer 20 are eroded. It is likewise possible that surface 35 of windings 9 is manufactured through etching away with hydrofluoric acid (HF). This design of the upper marginal regions of the spiral spring extends at least along the oscillation region.

In FIG. 9, an embodiment of the design of cross-section 17 of windings 9 of the oscillation region of spiral spring 4 is explained. Core 16, made of silicon material, has masking 34 on the lateral surface of windings 9 defined by short side 24_{O}. The effect of masking 34 is that the thermal oxidation of the silicon material of core 16, and the growth of SiO₂ layer 20 in the region of masking 34 occur differently, and thus lead to a different formation of SiO₂ layer 20. Masking 34 is a diffusion barrier for oxygen. In a preferred embodiment, masking 34 can consist of silicon nitride. At lateral surfaces 22, core 16 is not covered by masking 34 and is thus accessible to oxygen unhindered. Due to the thermal oxidation, SiO₂ layer 20 grows on lateral surfaces 22, which form so-called “bird beaks” 42 on both sides, in the region of continuously differentiable upper section 15_{O}, which extend below masking 34. Masking 34 is consumed by the thermal oxidation on the margins.

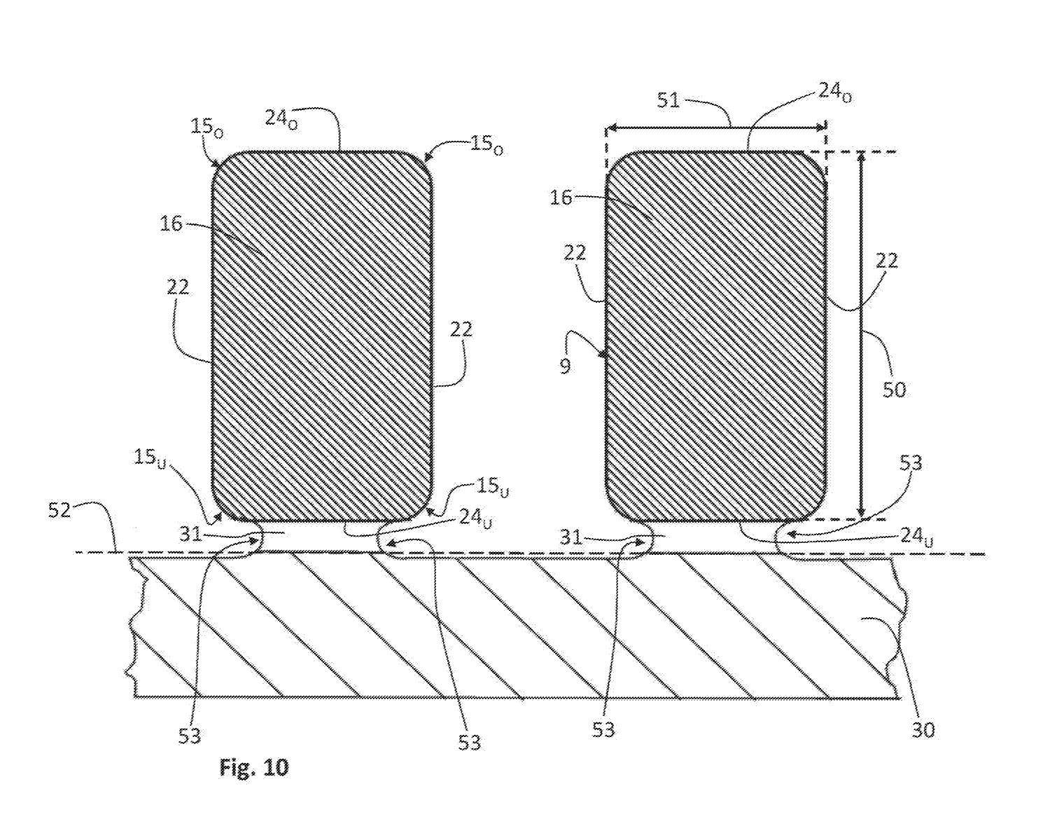

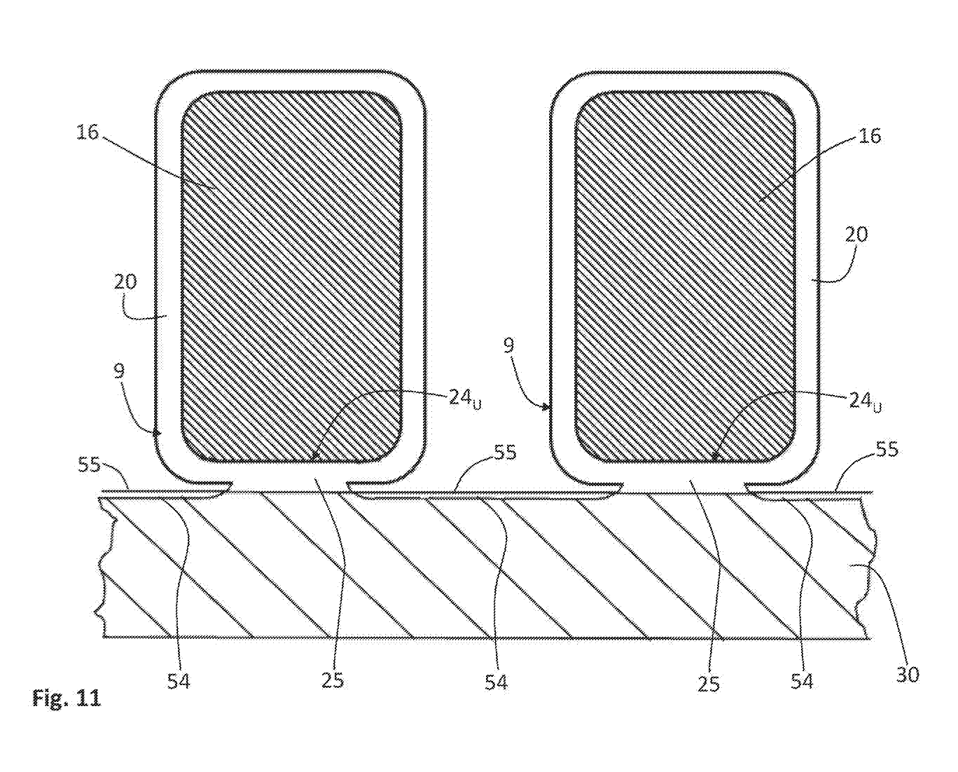

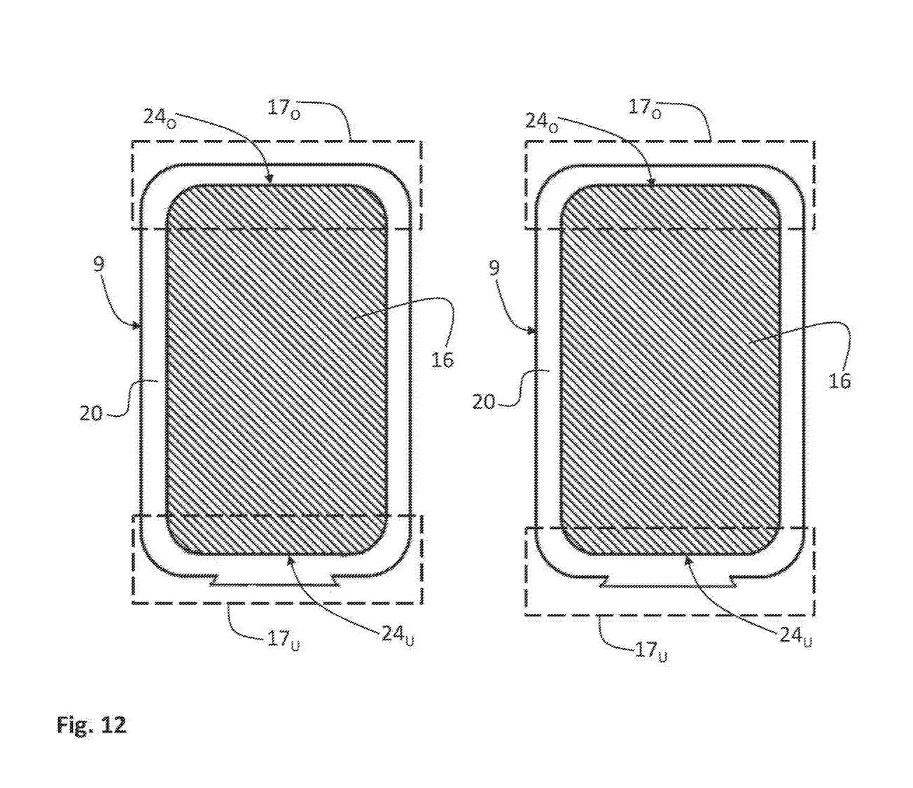

FIG. 10 is a schematically enlarged view of a cross-section of windings 9 of the spiral spring, which have been exposed from the surrounding silicon material (not shown here) by an etching process and are still connected to support 30. In the embodiment shown here, support 30 is coated with separating layer 31. This separating layer preferably consists of SiO₂, the same material that grows on core 16 of windings 9 during the thermal oxidation.

Windings 9 of spiral spring 4 formed out of silicon material 32 (see FIG. 6A) during the etching process and have etching height 50 and etching width 51. Through the etching, lateral surfaces and long sides 22 of windings 9 of spiral spring 4 are exposed. Similarly, upper, short, and straight sides 24_{O}, and lower, short, and straight sides 24_{U} of windings 9 are formed. Windings 9 are connected to support 30 by way of lower, short, and straight sides 24_{U} over the remaining separating layer 31. The etching process of windings 9 is, in this embodiment, designed such that between every two adjacent windings 9, etching is performed below original level 52 of support 30. Similarly, rear etchings 53 are formed in separating layer 31 during the etching procedure. Continuously differentiable upper sections 15_{O} and continuously differentiable lower sections 15_{U} of core 16 of windings 9 are also formed by way of the etching procedure.

FIG. 11 shows the situation where windings 9 were subjected to a thermal oxidation for a predetermined length of time after the etching procedure. Through the thermal oxidation, SiO₂ layer 20 is formed on the freely accessible lateral surfaces of core 16 of windings 9. Similarly, a thermal oxidation of support 30 and the erosion of layer 55 occurs at those spots 54 of support 30 which were exposed during the etching process. During the thermal oxidation, a portion of the silicon material of core 16 is converted into SiO₂. Core 16 of each winding 9 is now completely surrounded by SiO₂ layer 20. In the region of lower, short, and straight side 24_{U}, each winding 9 is connected to support 30 by way of SiO₂ bridge 25.

In FIG. 12, the final processing step for the manufacturing of spiral 4 with several windings 9 is shown. Support 30 was completely eroded (chemically and/or mechanically). Core 16 of windings 9, which form spiral 4 (not shown here), is in this embodiment completely surrounded with SiO₂ layer 20. In windings 9 which have been manufactured in accordance with this embodiment of the method, upper cross-section form 17_{O}, in the region of upper, short, and straight side 24_{O}, differs from lower cross-section form 17_{U}, in the region of lower, short, and straight side 24_{U}. The drawing illustrating the difference between upper cross-section form 17_{O}, and lower cross-section form 17_{U}, is only meant to serve as an example and should not be interpreted as a limitation of the invention. Depending upon the adjusting parameters of the etching process and the parameters of the subsequent thermal oxidation, the degree of difference between upper cross-section form 17_{O}, and lower cross-section form 17_{U} can be influenced.

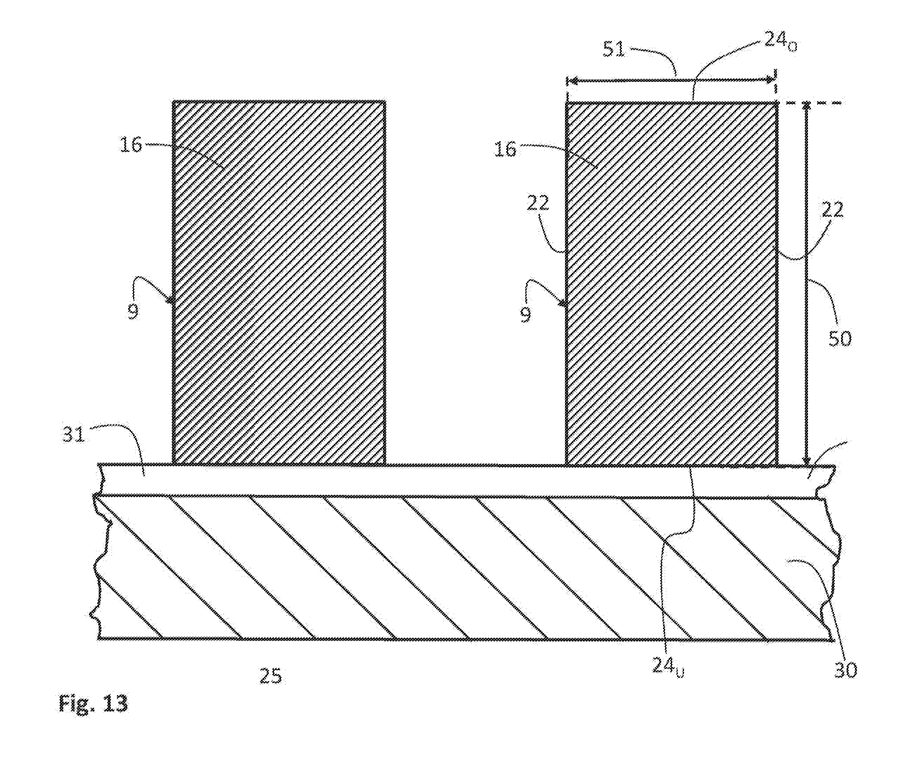

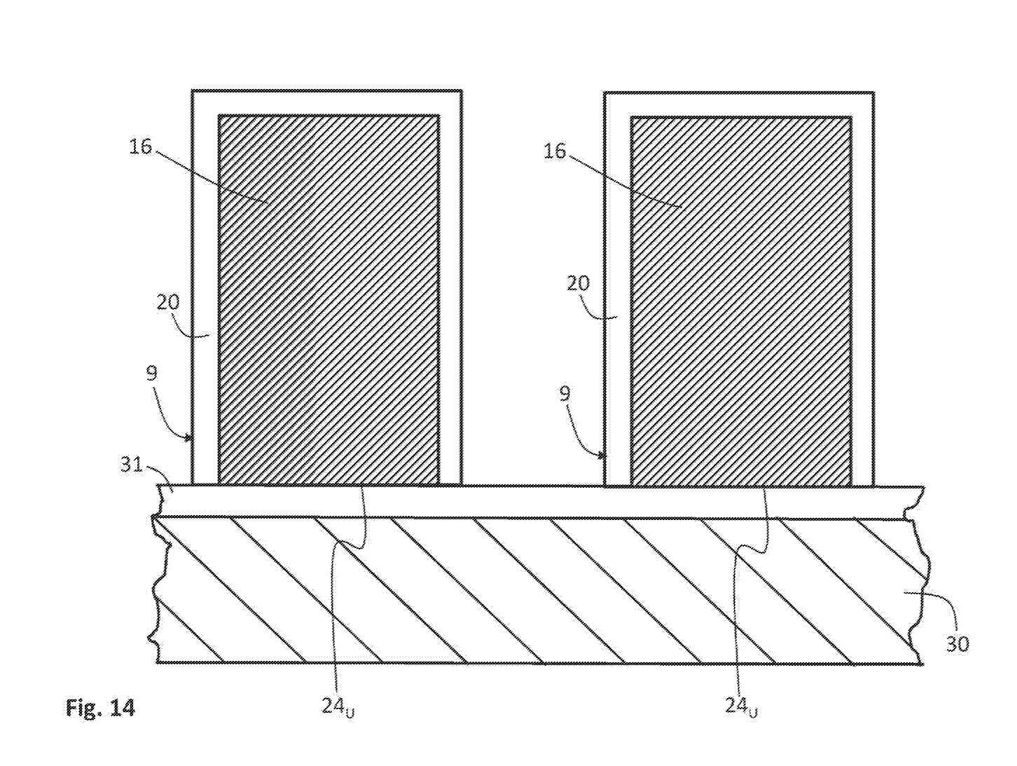

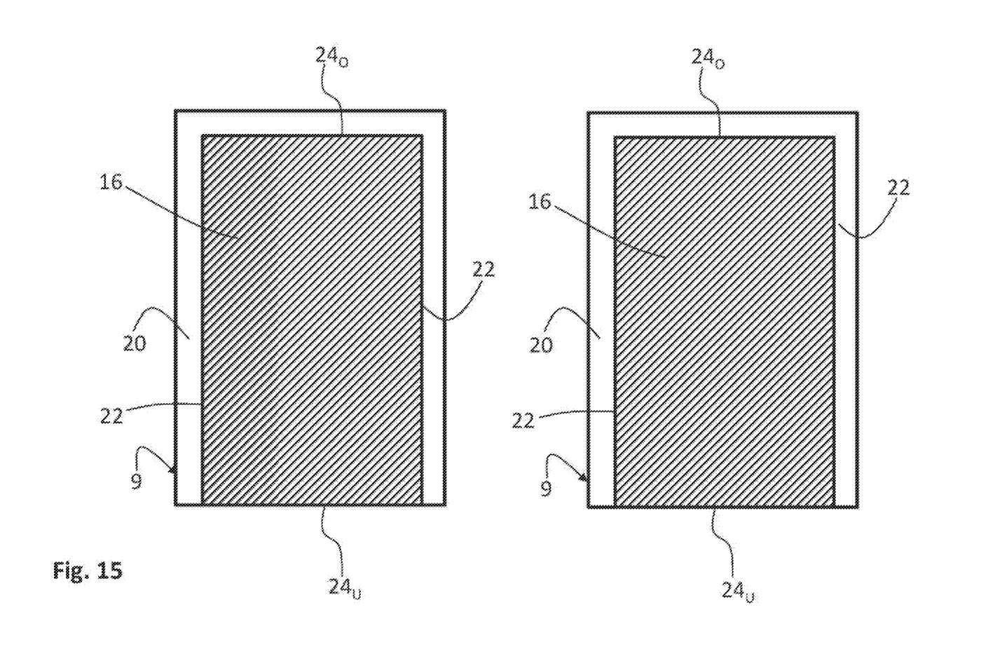

FIG. 13 is a schematically enlarged view of a further embodiment of the cross-section of windings 9 of the spiral spring, which have been exposed from the surrounding silicon material (not shown here) by an etching process, and are still connected to support 30. In the embodiment shown here, support 30 is coated with separating layer 31. This separating layer 31 preferably consists of SiO₂, the same material that grows on core 16 of windings 9 during the thermal oxidation. Windings 9 of spiral spring 4 formed during the etching process have etching height 50 and etching width 51. Through the etching, lateral surfaces and long sides 22 of windings 9 of spiral spring 4 are exposed. Similarly, upper, short, and straight sides 24_{O}, and lower, short, and straight sides 24_{U} of windings 9 are formed. Windings 9 are connected to support 30 by way of lower, short, and straight sides 24_{U} over separating layer 31. Separating layer 31 can consist of the same material as layer 20, which is applied for the compensation of the thermal expansion coefficient to the at least one lateral surface of windings 9 of the spiral spring.

FIG. 14 shows the situation where windings 9 were subjected to a thermal oxidation for a predetermined length of time after the etching procedure. Through the thermal oxidation, for example, SiO₂ layer 20 forms on the freely accessible lateral surfaces of core 16 of windings 9. During the thermal oxidation, a portion of the silicon material of core 16 is converted into SiO₂. Core 16 of each winding 9 is now surrounded by SiO₂ layer 20 on the freely accessible lateral surfaces. In the region of lower, short, and straight side 24_{U}, each winding 9 is still connected to support 30.

In FIG. 15, the final processing step for the manufacturing of spiral 4 with several windings 9 is shown. Support 30 and the separating layer were completely eroded in this embodiment (chemically and/or mechanically). Core 16 of windings 9, which form spiral 4 (not shown here), is in this embodiment surrounded with SiO₂ layer 20 at the lateral surfaces defined by long sides 22 and by upper, short, and straight side 24_{O}. At the lateral surface defined by lower, short, and straight side 24_{U}, there is no SiO₂ layer 20, because the separating layer was also eroded. Similarly, in a further thermal oxidation process, oxide layer 20 can be applied to lower, short, and straight side 24_{U}.

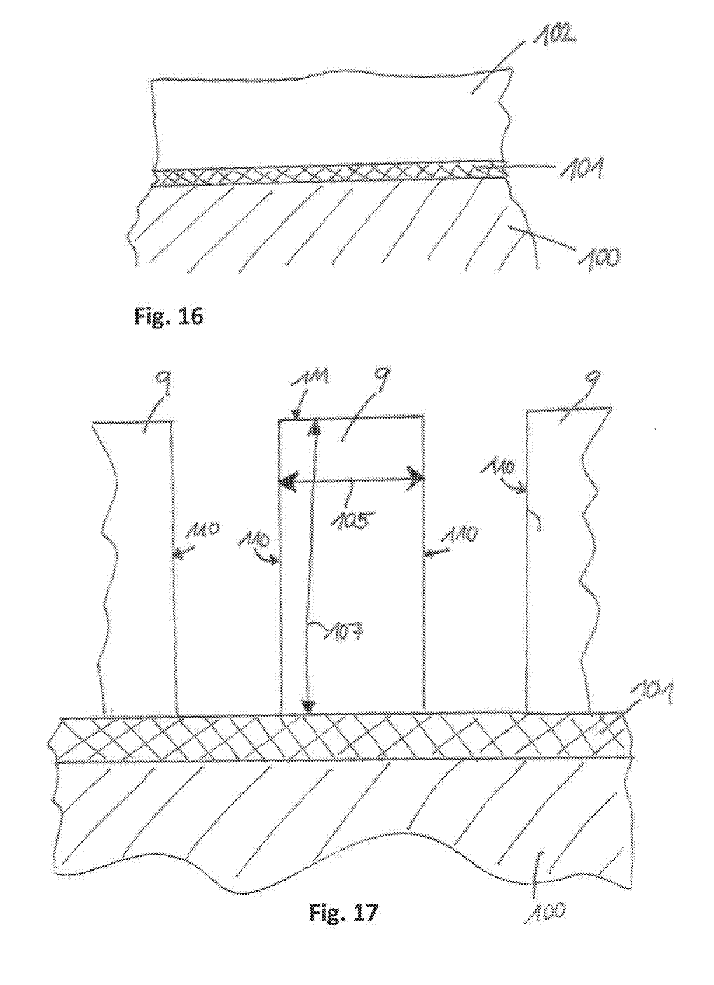

In FIGS. 16 through 20, a further embodiment of a method is described, with which the width of oxidized windings 9 of spiral spring 4 can be precisely adjusted.

FIG. 16 describes the structure of support 100, which in this embodiment has separating layer 101. Material layer 102 is applied to separating layer 101 for core 16 of windings 9 of spiral spring 4. As mentioned above, this is only of several possible embodiments of the invention and should not be interpreted as a limitation thereof.

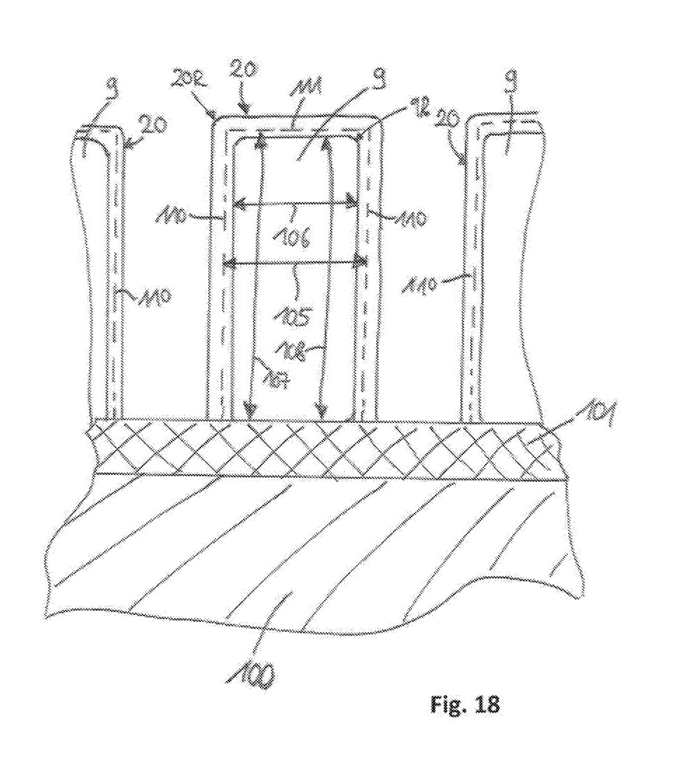

In the drawing in FIG. 17, windings 9 of spiral spring 4 in material layer 102 are etched with etching width 105 and etching height 107. Through the etching, lateral surfaces 110 and lateral walls of windings 9 of spiral spring 4 are exposed. Separating layer 101 can serve as a stopping layer for the etching procedure of windings 9. Similarly, in the etching procedure upper lateral surface 111 is formed. FIG. 18 shows the situation where windings 9 have been subjected to a thermal oxidation for a predetermined length of time after the etching procedure. Through the thermal oxidation, SiO₂ layer 20 forms on two freely accessible lateral surfaces 110, and freely accessible upper lateral surface 111. During the thermal oxidation, a portion of the silicon material of core 9 is converted into SiO₂. Original etching width 105 of each winding 9 of the core is thereby reduced to lower oxidation width 106 of core 16 of winding 9. Similarly, by way of the thermal oxidation, original etching height 107 of winding 9 is reduced to oxidation height 108. Through the etching procedure, core 9 can form rounds 9R. Consequently, SiO₂ layer 20 also forms rounds 20R.

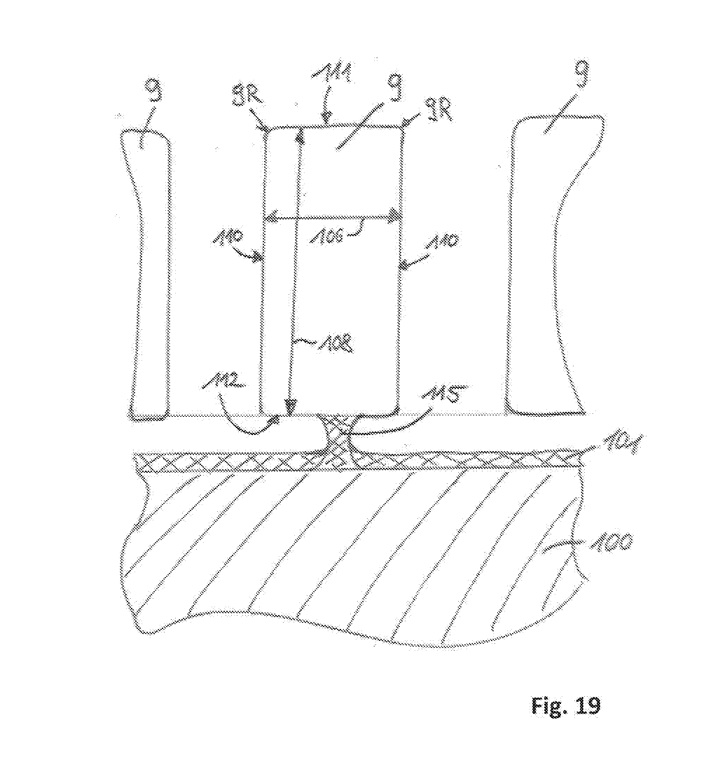

In FIG. 19, the next step of a further inventive method for the manufacturing of spiral spring 4 is graphically shown. In the step following the thermal oxidation, SiO₂ layer 20 from FIG. 18 is removed. The removal of SiO₂ layer 20 occurs by way of methods that are commonly known to one having ordinary skill in the art. Upon removal of SiO₂ layer 20, at least part of separating layer 101 is also eroded. As a result, windings 9 for the spiral spring are obtained whose dimensions include oxidation width 106 and oxidation height 108. Further, due to the at least partial removal of separating layer 101, at least a partial region of lower lateral surface 112 can be exposed and thus made accessible. The removal of separating layer 101 is adjusted, such that lower lateral surface 112 of winding 9 is joined to support 100 by way of ridge 115 of separating layer 101.

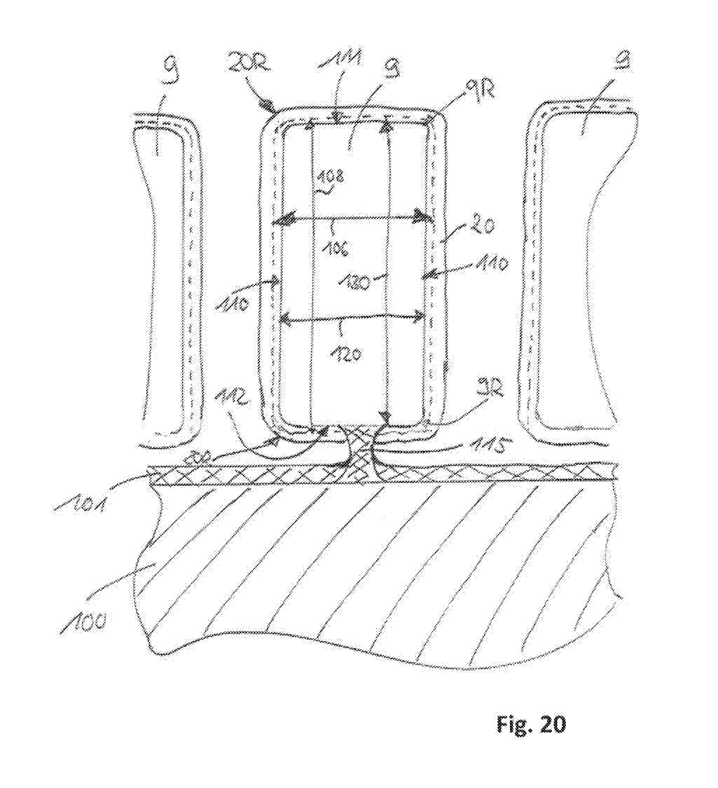

In FIG. 20, the final processing step for windings 9 is shown. Support 100, upon which multiple spirals with windings 9 are formed, is subjected to an additional thermal oxidation. Because lateral surfaces 110, upper lateral surfaces 111, and at least a portion of lower lateral surfaces 112 are freely accessible, SiO₂ layer 20 is formed on these by way of the thermal oxidation. As mentioned above in the description for FIG. 18, a portion of the silicon material of the core of windings 9 is also converted into SiO₂ during this oxidation. This results in a core of winding 9 made of silicon material (e.g. polysilicon), which possesses width 120 and height 130, which is smaller than oxidation width 106 and oxidation height 108. Ridges 115 continue to hold spiral springs on support 100. In order to detach spiral springs, support 100 is removed through conventional means. Ridges 115 can remain in place or can also be completely removed. The additional oxidation has the advantage that width 120 and height 130 of windings 9 of the spiral spring can be precisely adjusted. It is thus possible to adjust the mechanical properties of the spiral spring as desired.

The manufacturing methods described here have the advantage that the spiral springs can be manufactured from silicon material (e.g. polycrystalline silicon) without warping. Further, the spiral springs manufactured in this way demonstrate a long-term excellent oscillation behavior and possess stability and resistance to spring fractures. The spiral spring is also reproducible in terms of its oscillation behavior, without neglecting the necessary temperature compensation.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

1 Oscillation system
2 Fly wheel
2.1 Annular ring
2.2 Spoke
2.3 Nave section
2.4 Fly wheel
3 Balance shaft
3′ Shaft section
3″ Shaft section
3.1 Upper free end
3.2 Lower free end
4 Spiral spring
4.1 Spiral spring mounting section
4.2 Spiral spring end section
4.3 Spiral spring ring section
5 Holding arrangement
6 Holding arm
6.1 Inner holding arm
6.2 Outer holding arm
6.3 Guide groove
7 Holding element
7.1 Base body
7.2 Blind borehole
7.3 Guide groove
7.11 Upper front face
7.12 Lower front face
8 Screw
9 Winding
9R Round
13 Inner round
15_{O} continuously differentiable upper section
15_{U} continuously differentiable lower section
16 Core
17 Cross-section
17O Cross-section form
17U Cross-section form
20 Layer, SiO₂ layer
20R Round
22 Long side
24_{O} Upper, short, straight side
24_{U} Lower, short, straight side
25 Bridge, SiO₂ bridge
30 Support
31 Separating layer
32 Silicon material
33 Layer
34 Masking
35 Surface
42 Bird beak
50 Etching height
51 Etching width
52 Original level
53 Rear etching
54 Exposed points
55 Layer
100 Support
101 Separating layer
102 Material layer
105 Etching width
106 Oxidation width
107 Etching height
108 Oxidation height
110 Lateral surfaces
111 Upper lateral surface
115 Ridge
120 Width
130 Height
A Distance
B Width
H Height
L1 Length
L2 Length
LA Oscillation region
LS Stabilizing region
LHA Longitudinal axis
LHE Longitudinal axis
UA Axis

What is claimed is:

1. A spiral spring with at least one winding, comprising a core of a silicon material, wherein the core comprises two long, parallel, straight sides and two short, parallel, straight sides, wherein at least the opposing long sides of the core are covered by a SiO₂ layer.

2. The spiral spring as recited in claim 1, wherein the upper short and straight side and the opposing long sides are covered by a SiO₂ layer.

3. The spiral spring as recited in claim 1, wherein:
the upper short and straight side is joined to the opposing long sides on both sides by a continuously differentiable upper section, respectively, and,
the opposing long and straight sides, the respective continuously differentiable upper sections which join the short and straight side to the opposing long and straight sides on both sides, and the upper short and straight side are covered by a SiO₂ layer.

4. The spiral spring as recited in claim 3, wherein the lower short and straight side is covered by a SiO₂ layer, which differs in thickness of the SiO₂ layer at the opposing long sides and the SiO₂ layer at the upper short and straight side.

5. The spiral spring as recited in claim 1, wherein:
the upper short and straight side is joined to the opposing long sides on both sides by a continuously differentiable upper section, respectively;
the lower short and straight side is joined to the opposing long and straight sides on both sides by a continuously differentiable lower section, respectively; and,
the core is covered by a SiO₂ layer, at least at the opposing long and straight sides, and at the respective continuously differentiable upper section, and the respective continuously differentiable lower section.

6. The spiral spring as recited in claim 5, wherein the two continuously differentiable upper sections differ from the lower continuously differentiable sections.

7. The spiral spring as recited in claim 5, wherein the lower short side and the short upper side have a SiO₂ layer, such that the core so is surrounded by a SiO₂ layer, where the thickness and/or form of the SiO₂ layer differs at the lower short side and the upper short side.

8. The spiral spring as recited in claim 1, wherein the spiral spring comprises a spiral spring mounting section, a spiral spring end section, and at least one spiral spring ring section lying between them.

9. A mechanical watch with the spiral spring as recited in claim 1.

10. A method for the manufacturing of a spiral spring from a silicon material, comprising:
providing a support;
applying a silicon material on the support, wherein the silicon material forms a core of at least one winding of the spiral spring;
etching of the at least one winding of the spiral spring, such that the core of the at least one winding of the spiral spring is formed, comprising two long, parallel, straight sides and two short, parallel, straight sides;
carrying out a thermal oxidation, wherein a layer of an oxide grows at least on the lateral surfaces of the spiral spring defined and exposed by the long sides; and,
removing the support from the silicon material.

11. The method as recited in claim 10, wherein during the step of carrying out the thermal oxidation, the layer of the oxide grows on the lateral surfaces defined and exposed by the long sides and on the lateral surfaces of the spiral spring defined and exposed by the upper short, straight sides.

12. The method as recited in claim 10, wherein:
the upper short and straight side is joined to the opposing long sides on both sides by a continuously differentiable upper section, respectively, and,
wherein during the step of carrying out the thermal oxidation, the layer of the oxide grows on the lateral surfaces defined and exposed by the long sides, the continuously differentiable upper sections, and the upper short, straight side.

13. The method as recited in claim 10, wherein:
the upper short and straight side is joined to the opposing long sides on both sides by a continuously differentiable upper section, respectively; and,
a lower short and straight side is joined to the opposing long sides on both sides by a continuously differentiable lower section, respectively.

14. The method as recited in claim 13, wherein the step of etching of the at least one winding of the spiral spring is performed such that in the region of the lower side of the core a rear etching is formed, such that at least the continuously differentiable lower section, which joins the opposing long sides with the lower short and straight sides on both sides, respectively, is spaced apart from the support.

15. The method as recited in claim 13, wherein:
a separating layer is provided between the support and the silicon material for the core of the at least one winding of the spiral spring; and,
the step of etching of the at least one winding of the spiral spring is performed such that in the region of the lower, short, straight side of the core, a rear etching is formed at least in the separating layer, such that at least the continuously differentiable lower section, which joins the opposing long sides with the lower short and straight sides on both sides, respectively, is spaced apart from the support.

16. The method as recited in claim 15, wherein the step of etching of the at least one winding of the spiral spring is performed such that etching is performed below an original level of the support.

17. The method as recited in claim 10, wherein a layer of a material for compensating the thermal expansion coefficient of the silicon material of the core of the at least one winding is applied to the boundary surfaces, exposed by the etching process, of the at least one winding.

18. The method as recited in claim 17, wherein the material for the compensating the thermal expansion coefficient is the same material as that of the separating layer.

19. The method as recited in claim 17, wherein the material of the layer for compensating the thermal expansion coefficient of the silicon material is a SiO₂ layer formed by way of thermal oxidation of the silicon material of the core.

20. The method as recited in claim 10, wherein the removal of the support can be performed mechanically and/or chemically.

21. A mechanical watch with a spiral spring, wherein the spiral spring is manufactured by the method as recited in claim 10.
